(19) United States
(12) Patent Application Publication
(10) Pub. No.: US 2024/0206436 A1
(43) Pub. Date: Jun. 27, 2024

(54) AQUACULTURE METHOD FOR PREVENTING TILAPIA FATTY LIVER DISEASE

(71) Applicant: GUANGDONG OCEAN UNIVERSITY, Guangdong (CN)

(72) Inventors: Jia CAI, Guangdong (CN); Jichang JIAN, Guangdong (CN); Jufen TANG, Guangdong (CN); Liqun XIA, Guangdong (CN); Yu HUANG, Guangdong (CN)

(21) Appl. No.: 17/911,589

(22) PCT Filed: Jun. 7, 2022
(86) PCT No.: PCT/CN2022/097273

§ 371 Date: Jan. 26, 2023

(30) Foreign Application Priority Data
Jul. 21, 2021 (CN) 202110824299.2

(51) Int. Cl. A01K 61/13

(52) U.S. Cl. CPC A01K 61/13

(57) ABSTRACT

The present disclosure provides an aquaculture method for preventing tilapia fatty liver disease. The aquaculture method includes steps of: dropping tilapia fries in an aquaculture pond for feed-based aquaculture for 28-31 days, fasting and refeeding, and conducting the feed-based aquaculture until harvest. Through the aquaculture method provided by the present disclosure, lipid increase in hepatocytes is reduced significantly, and glutamic-pyruvic transaminase (GPT), glutamic-oxal(o)acetic transaminase (GOT), lactic dehydrogenase (LDH), and alkaline phosphatase (AKP) show a significant decrease in activity. Thus, the aquaculture method achieves an effective the effect of control the nutritional fatty liver disease in tilapia aquaculture.

### CROSS-REFERENCE TO RELATED APPLICATION

This patent application claims the benefit and priority of Chinese Patent Application No. 202110824299.2, filed with the China National Intellectual Property Administration (CNIPA) and entitled AQUACULTURE METHOD FOR PREVENTING TILAPIA FATTY LIVER DISEASE filed on Jul. 21, 2021, the disclosure of which is incorporated by reference herein in its entirety as part of the present application.

### TECHNICAL FIELD

The present disclosure relates to the technical field of aquaculture, and in particular to an aquaculture method for preventing tilapia from fatty liver disease.

### BACKGROUND ART

Tilapia, also known as African crucian or white salmon, is a cultured species recommended to the world by the Food and Agriculture Organization of the United Nations. In recent years, with the expansion of aquaculture area of tilapia and the increase of stocking density; the problem of diseases in tilapia has become increasingly serious. Nutritional fatty liver disease caused by feed quality, feed nutritional imbalance and other factors is a common disease, which seriously impedes the healthy and sustainable development of tilapia aquaculture. Fatty liver disease can cause retarded growth of tilapia, decreased stress resistance, and even mass mortality in hot seasons. Commercial fish with fatty liver disease may cause abdominal enlargement that influences appearance quality.

In intensive aquaculture of tilapia, once the fatty liver disease occurs, it tends to be massive and all-round. It mainly endangers fingerlings and adult fish cultured in a high-density manner, particularly the mature individuals. Although such a disease is noninfectious, its hazards and consequences are far more serious than those infectious diseases. In severe cases, it induces infectious diseases and other syndromes, causes huge production losses, and brings down initiatives of farmers. Thus, how to reduce hepatic steatosis in tilapias and increase the absorption and utilization of dietary fats to achieve the goal of promoting the healthy aquaculture of tilapia has become an important problem that is urgent to be solved. In the prior art, tilapia fatty liver is generally prevented by adjusting the tilapia feed formulation or the feed additive, and the tilapia fatty liver disease is further alleviated by controlling the current velocity to regulate the exercise intensity of swimming training of tilapia in counter-current. However, there is no report on the prophylaxis of tilapia fatty liver disease in a fasting-refeeding manner.

### SUMMARY

In view of this, an objective of the present disclosure is to provide an aquaculture method for preventing tilapia fatty liver disease, and the method can effectively control nutritional fatty liver disease in tilapia aquaculture.

To achieve the above objective, the present disclosure provides the following technical solution.

The present disclosure provides an aquaculture method for preventing tilapia fatty liver disease, including the following steps: dropping tilapia fries in an aquaculture pond for feed-based aquaculture for 28-31 days, fasting and refeeding the tilapia, and conducting the feed-based aquaculture until harvest.

Preferably, the tilapia fries each may be 28-32 g.

Preferably, a stocking density of the tilapia fries may be 1,800-2,200 fries/mu (mu is a Chinese area unit, 1 mu≈666.7 m2).

Preferably, the feed-based aquaculture may be implemented by feeding the fries twice in an amount of 3-8% of fry weight at 6:00 a.m. and 17:00 p.m. every day.

Preferably, the fries are fed in the same quantity in each feeding.

Preferably, the fasting may last 7-14 days.

Preferably, the refeeding may be carried out in an incremental feeding pattern.

Further preferably, daily feed quota in the incremental feeding may be provided incrementally in an increment of 1-4% of the fry weight at each stage until a final feeding quantity reaches 3-8% of the fry weight.

Further preferably, aquaculture time at each stage of the incremental feeding may be 4-11 days.

Compared with the prior art, the present disclosure has the following beneficial effects:

The aquaculture method provided by the present disclosure can mitigate lipid increase in hepatocytes significantly, and glutamic-pyruvic transaminase (GPT), glutamic-oxal(o)acetic transaminase (GOT), lactic dehydrogenase (LDH), and alkaline phosphatase (AKP) show a significant decrease in activity, achieving the effect of controlling the nutritional fatty liver disease in tilapia aquaculture.

In the present disclosure, it is the first time to breed the tilapias through short-term fasting breeding. The fasting achieves the effect of mitigating lipid increase in tilapia hepatocytes and thus controlling the tilapia fatty liver disease without affecting the tilapia yield.

### BRIEF DESCRIPTION OF THE DRAWINGS

FIG. 1 illustrates the microscopic observations of Oreochromis niloticus liver sections in Comparative Example 1 and Example 1.

FIG. 2 illustrates the microscopic observations of O. niloticus liver sections in Comparative Example 2 and Example 1.

FIG. 3 illustrates the changes in expression levels of interleukin-6 (IL-6) in O. niloticus serum at different stages.

FIG. 4 illustrates the changes in expression levels of interleukin-1ß (IL-1B) in O. niloticus serum at different stages.

### DETAILED DESCRIPTION OF THE EMBODIMENTS

The present disclosure will be further described below with reference to the examples and accompanying drawings.

The present disclosure provides an aquaculture method for preventing tilapia fatty liver disease, including the following steps: dropping tilapia fries in an aquaculture pond for feed-based aquaculture for 28-31 days, then fasting, and refeeding the tilapia, and conducting the feed-based aquaculture until harvest.

In the present disclosure, the aquaculture pond may optionally be an outdoor concrete pond: the tilapia fries each may preferably be 28-32 g, and more preferably 30 g.

In the present disclosure, a stocking density of the tilapia fries may be 1,800-2,200 fries/mu, and more preferably 2,000 fries/mu. In tilapia aquaculture provided by the present disclosure, high-density aquaculture may reduce dissolved oxygen concentration in water, resulting in a decrease in water quality; low-density aquaculture may cause a waste of breeding resources and reduce economic benefits.

In the present disclosure, the feed-based aquaculture may preferably be implemented by feeding the fries twice with feedstuff in an amount of 3-8% of fry weight at 6:00 a.m. and 17:00 p.m. everyday: The fries may be fed in the same quantity in each feeding. More preferably, the feed-based aquaculture may be implemented by feeding the fries in an amount of 5% of fry weight, and both two feedings may preferably be implemented by 2.5% of fry weight. In the present disclosure, the feed may be a commercial extruded formula feed for tilapia.

In the present disclosure, the fasting may preferably last for less than 21 days, more preferably 7-14 days, and further preferably 10 days. In the present disclosure, too long fasting time may cause inflammatory responses, and too short fasting time may not achieve the effect of controlling the tilapia fatty liver disease.

In the present disclosure, the refeeding may be carried out in an incremental feeding pattern: the daily feed quota in the incremental feeding may preferably be provided incrementally by 1-4% of fry weight at each stage until a final feeding quantity reaches 3-8%, the daily feed in the incremental feeding may more preferably be fed incrementally by 1-2.5% of the fry weight at each stage until the final feeding quantity may preferably be 3-5%, and the daily feed in the incremental feeding may further preferably be fed incrementally by 1.5-3% of the fry weight at each stage until the final feeding rate may further preferably be 4-7%. In the present disclosure, the incremental feeding may optionally be implemented by feeding the fries by 1%-2.5%-5% of the fry weight everyday; and feeds in the refeeding may be consistent with those before the fasting.

In the present disclosure, aquaculture time at each stage of the incremental feeding may preferably be 4-11 days, more preferably 5-7 days, and further preferably 7 days.

The technical solution provided by the present disclosure will be described in detail below by referring to the examples, but they should not be construed as limiting the protection scope of the present disclosure.

### Example 1

### Aquaculture Site: Outdoor Concrete Aquaculture Pond

### S1. Early Aquaculture of Fish Fries

Healthy O. niloticus fries were weighed in advance. Their initial body weight was 30±2 g. The fish fries were dropped in an aquaculture pond at a density of 2,000 fries/mu. The fish fries were fed twice with feedstuff in a daily quota of 5% of the fry weight at 6:00 a.m. and 17:00 p.m. everyday. The feeding quota for either feeding was 2.5% of the fry weight. The fish fries were bred normally for 30 days.

### S2. Short-Term Fasting

After thirty days of normal breeding, O. niloticus in the pond were fasted for 21 days.

### S3. Refeeding

After twenty-one days of fasting, O. niloticus in the pond were fed incrementally in an increment of 1%-2.5%-5% of the fry weight, and the aquaculture time at each feeding stage was 7 days, until harvest.

During the aquaculture process, the fish fries were sampled on days 0, 7, 14, 21, 28, 35, and 42 of the fasting period, O. niloticus were weighed, and the liver tissue sections were stained. The activity of GPT, GOT, LDH, and AKP in serum was detected, and the expression levels of inflammatory factors IL-6 and IL-1β in serum were determined.

### Example 2

Aquaculture site: Outdoor concrete aquaculture pond

### S1. Early Aquaculture of Fish Fries

Healthy O. niloticus fries were weighed in advance. Their initial body weight was 30±2 g. The fish fries were dropped in an aquaculture pond at a density of 2, 200 fries/mu. The fish fries were fed twice with feedstuff in a daily quota of 3% of the fry weight at 6:00 a.m. and 17:00 p.m. everyday. The feeding quota for either feeding was 1.5% of the fry weight. The fish fries were bred normally for 30 days.

### S2. Short-Term Fasting

After thirty days of normal breeding, O. niloticus in the pond were fasted for 7 days.

### S3. Refeeding

After seven days of fasting, O. niloticus in the pond were fed incrementally in an increment of 1%-2.5%-5% of the fry weight, and the aquaculture time at each feeding stage was 12 days, until harvest.

During aquaculture, the fish fries were sampled on days 0, 7, 14, 21, 28, 35, and 42 of the fasting period, and O. niloticus were weighed.

### Example 3

Aquaculture site: Outdoor concrete aquaculture pond

### S1. Early Aquaculture of Fish Fries

Healthy O. niloticus fries were weighed in advance. Their initial body weight was 30±2 g. The fish fries were dropped in an aquaculture pond at a density of 2,000 fries/mu. The fish fries were fed twice with feedstuff in a daily quota of 8% of the fry weight at 6:00 a.m. and 17:00 p.m. everyday. The feeding quota for either feeding was 4% of the fry weight. The fish fries were bred normally for 28 days.

### S2. Short-Term Fasting

After twenty-eight days of normal breeding, O. niloticus in the pond were fasted for 14 days.

### S3. Refeeding

After fourteen days of fasting, O. niloticus in the pond were fed incrementally in an increment of 2%-4%-7% of the fry weight, and the aquaculture time at each feeding stage was 10 days, until harvest.

Sampling and detection were the same as those in Example 2.

### Comparative Example 1

### Aquaculture Site: Outdoor Concrete Aquaculture Pond

The aquaculture solution was subjected to the method described in S1 of Example 1, and the fish fries were bred normally until harvest.

Sampling and detection were the same as those in Example 1.

### Comparative Example 2

### Aquaculture Site: Outdoor Concrete Aquaculture Pond

The breeding methods in S1 and S2 were the same as those in Example 1.

### S3. Refeeding

After twenty-one days of fasting, O. niloticus in the pond were fed with feedstuff in an amount 5% of the fry weight until harvest.

During aquaculture, the fish fries were sampled on Days 28, 35, and 42 of the fasting period, and the liver tissue sections were stained.

TABLE 1
Measurement results of body weights of
O. niloticus at different breeding stages

| | Comparative | | | | |
|---|---|---|---|---|---|
| Time | Example 1 | Example 1 | Example 2 | Example 3 | Significant |
| (day) | (g) | (g) | (g) | (g) | difference |
| 0 | 31.2 | 31.14 | 31.31 | 31.25 | ns |
| 7 | 34.78 | 32.56 | 33.29 | 33.51 | ns |
| 14 | 37.68 | 31.52 | 31.86 | 32.08 | s |
| 21 | 41.06 | 29.32 | 30.78 | 31.03 | s |
| 28 | 44.86 | 37.67 | 39.71 | 38.87 | s |
| 35 | 47.46 | 44.98 | 46.01 | 45.96 | s |
| 42 | 50.73 | 49.89 | 52.12 | 50.81 | ns |

NOTE:
ns represents no significant difference (P > 0.05), and s represents a significant difference (P < 0.05)

### Example 4

### Tissue Sectioning and Staining

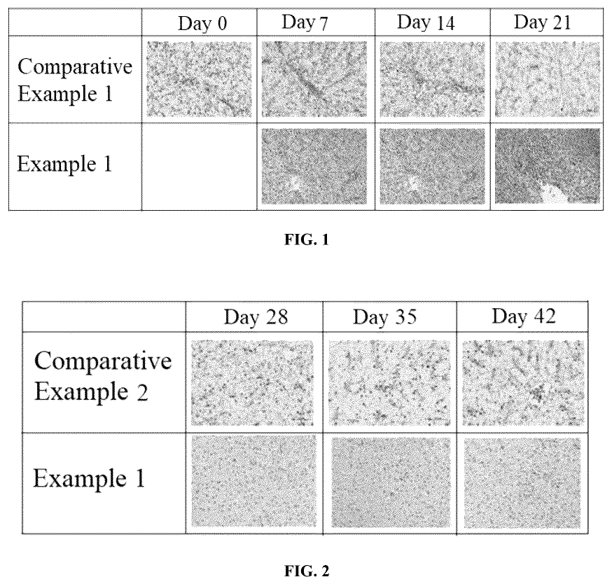

Differences in liver between Example 1 and Comparative Examples 1 and 2 were observed through liver sections. Specific steps were as follows:
step 1, the liver was fixed and tissue sections were prepared;
step 2, the tissue sections were washed with precooled phosphate buffered saline (PBS) thrice;
step 3, the tissue sections were fixed with 4% paraformaldehyde solution (tissue fixative) for 24 h;
step 4, the tissue sections were dehydrated with 80%-95%-100% gradient ethanol;
step 5, paraffin embedding and sectioning: the tissue sections were permeabilized with xylene, embedded in paraffin, cooled, solidified, and sectioned using a microtome to yield 5 μm thick sections;
step 6, the section was attached onto a glass slide, dried in a incubator at 45° C., and deparaffinized with xylene twice, for 15 min each time;
step 7, rehydration was conducted with 100% ethanol for 5 min, repeated twice, and conducted with 80% ethanol for 5 min;
step 8, hematoxylin-eosin (HE) staining was conducted;
step 9, after preparing the sections using conventional methods, photos were taken under a microscope and saved. Results are shown in FIGS. 1 and 2.

It is seen in FIG. 1, satiation of O. niloticus leads to a lipid increase in hepatocytes, and even nuclear migration and vacuolation of cells After starving for 7-14 days, these conditions can be improved significantly and the hepatocyte morphology is restored. However, if the starvation time exceeds 14 days, inflammatory response may be caused.

It is seen in FIG. 2, after O. niloticus is starved, immediate satiate feeding (feeding in an amount of 5% of the fry weight) aggravates lipidization of hepatocytes and the liver of O. niloticus is damaged. After moderate starvation (for 7-14 days preferably), incremental feeding (1%-2.5%-5%) can improve the damage caused by satiation feeding.

Changes in expression of inflammatory factors IL-6 and IL-1β in serum

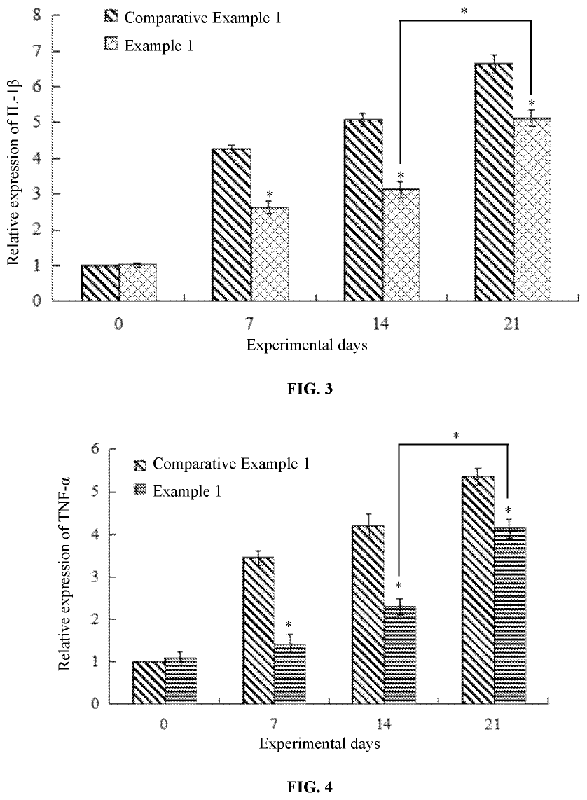

The expression level of inflammatory regulatory factor Hsp70 was detected by fluorescence quantitative PCR. Specific steps included as follows: specific primers were designed according to the conserved domain of the sequence of O. niloticus, and with β-actin gene as reference, relative expression levels of inflammatory factors IL-6 and IL-1β in blood of starved O. niloticus were analyzed by qRT-PCR. Results are shown in FIGS. 3 and 4.

The results in FIGS. 3 and 4 indicate that the level of the inflammatory factors in the blood of the fasted O. niloticus are significantly lower than those in satiated O. niloticus, but the expression levels of the inflammatory factors are significantly increased 14 days after fasting. Therefore, fasting for an appropriate length of time has no effect on health conditions of O. niloticus, but too long fasting time leads to inflammatory responses in O. niloticus.

Changes in activity of GPT, GOT, LDH, and AKP in O. niloticus serum were detected by using kits for detecting GPT, GOT, LDH, and AKP, and the kits were purchased from the Nanjing Jiancheng Bioengineering Institute.

### (1) GPT Detection

S1. A reaction system was prepared in the following ratio:

TABLE 2
Reaction system for GPT detection

| Component | Detection well | Control well |
|---|---|---|
| Substrate buffer (μL) | 20 | 5 |
| Sample (μL) | 5 | 0 |

Gently shake the well plate, and incubate in a 37° C. gas bath for 30 min

| | | |
|---|---|---|
| Chromogenic agent (μL) | 20 | 20 |
| Sample (μL) | 0 | 5 |

Gently shake the well plate, and incubate in a 37° C. gas bath for 30 min

| | | |
|---|---|---|
| Applystop buffer | 200 | 200 |

S2. An ELISA plate was shaken carefully to mix well and was allowed to stand at room temperature for 15 min, and the OD value (n=4) of each well was measured at 510 nm using a microplate reader; and
S3. The measured OD value was substituted into the standard curve in the kit to directly calculate the activity of GPT in serum. Results are shown in Table 6.

### (2) GOT Detection

S1. A reaction system was prepared in the following ratio:

TABLE 3
Reaction system for GOT detection

| Component | Detection well | Control well |
|---|---|---|
| Substrate buffer (μL) | 20 | 5 |
| Sample (μL) | 5 | 0 |

Gently shake the well plate, and incubate in a 37° C. gas bath for 30 min

| | | |
|---|---|---|
| Chromogenic agent (μL) | 20 | 20 |
| Sample (μL) | 0 | 5 |

Gently shake the well plate, and incubate in a 37° C. gas bath for 30 min

| | | |
|---|---|---|
| Apply stop buffer | 200 | 200 |

S2. An ELISA plate was shaken carefully to mix well and was allowed to stand at room temperature for 15 min, and the OD value (n=4) of each well was measured at 510 nm using a microplate reader;
S3. The measured OD value was substituted into the standard curve in the kit to directly calculate the activity of GOT in serum. Results are shown in Table 6.

### (3) LDH Detection

S1. A reaction system was prepared in the following ratio:

TABLE 4
Reaction system for LDH detection

| | Blank | Standard | Detection | Control |
|---|---|---|---|---|
| Component | well | well | well | well |
| Buffer (μL) | 25 | 50 | 50 | 0 |
| Substrate buffer (μL) | 25 | 25 | 25 | 25 |
| Double distilled water (μL) | 25 | 0 | 0 | 5 |
| Application buffer of 0.2 | 0 | 20 | 0 | 0 |
| μmol/mL pyruvic acid | | | | |
| standard solution (μL) | | | | |
| Cozymase I (μL) | 0 | 0 | 5 | 0 |
| Sample (μL) | 0 | 0 | 20 | 20 |

Mix well and incubate in a 37° C. water bath for 15 min

| | | | | |
|---|---|---|---|---|
| 2,4-dinitrophenylhydrazine (μL) | 25 | 25 | 25 | 25 |

Mix well and incubate in a 37° C. water bath for 15 min

| | | | | |
|---|---|---|---|---|
| 0.4 mol/L NaOH solution (μL) | 250 | 250 | 250 | 250 |

S2. An ELISA plate was shaken carefully to mix well, and the OD value (n=4) of each well was measured at 520 nm using a microplate reader; and
S3. The measured OD value was substituted into a standard curve of in kit to directly calculate the activity of LDH in serum. Results are shown in Table 6.

### (4) AKP Detection

S1. A reaction system was prepared in the following ratio:

TABLE 5
reaction system for AKP detection

| | Blank | Standard | Detection |
|---|---|---|---|
| Component | well | well | well |
| Buffer (μL) | 50 | 50 | 50 |
| Substrate buffer (μL) | 50 | 50 | 50 |
| Double distilled water (μL) | 5 | 0 | 0 |
| Application buffer of 0.1 mg/mL | 0 | 5 | 0 |
| phenol standard solution (μL) | | | |
| Sample (μL) | 0 | 0 | 5 |

Mix well and incubate in a 37° C. water bath for 15 min

| | | | |
|---|---|---|---|
| Chromogenic agent (μL) | 150 | 150 | 150 |

S2. An ELISA plate was shaken carefully to mix well, and the OD value of each well was measured at 520 nm using a microplate reader.
S3. Calculation was conducted according to the following calculation formula: activity of AKP in serum=(measured OD value−blank OD value)/(standard OD value−blank OD value)×standard concentration (0.1 mg/mL)×dilution factor of sample. Results are shown in Table 6.

TABLE 6
Activity of GPT, AKP, GOT, and LDH in serum at each stage

| | | | |
|---|---|---|---|
| | Comparative | | Significant |
| Time (day) | Example 1 | Example 1 | difference |

GPT (U/L)

| | | | |
|---|---|---|---|
| 0 | 17.08 | 16.08 | ns |
| 7 | 16.08 | 11.32 | s |
| 14 | 14.38 | 10.47 | s |
| 21 | 16.43 | 10.73 | s |

GOT (U/L)

| | | | |
|---|---|---|---|
| 0 | 26.82 | 27.85 | ns |
| 7 | 30.54 | 26.24 | s |
| 14 | 38.78 | 25.92 | s |
| 21 | 37.98 | 24.71 | s |

LDH (U/L)

| | | | |
|---|---|---|---|
| 0 | 427.82 | 426.85 | ns |
| 7 | 483.05 | 427.90 | s |
| 14 | 496.24 | 426.54 | s |
| 21 | 485.71 | 407.98 | s |

AKP (U/L)

| | | | |
|---|---|---|---|
| 0 | 41.92 | 42.85 | ns |
| 7 | 45.17 | 38.35 | s |
| 14 | 46.54 | 39.24 | s |
| 21 | 47.98 | 36.71 | s |

NOTE:
ns represents no significant difference (P > 0.05), and s represents a significant difference (P < 0.05)

The results in Table 6 indicate that the activity of GPT, GOT, LDH, and AKP in sera of starved O. niloticus decreases significantly, indicating that the risk of fatty liver disease is lowered in fasted O. niloticus.

The above description is merely preferred implementation of the present disclosure. It should be noted that a person of ordinary skill in the art may further make several improvements and modifications without departing from the principle of the present disclosure, and such improvements and modifications should be deemed as falling within the protection scope of the present disclosure.

What is claimed is:

1. An aquaculture method for preventing tilapia fatty liver disease, comprising the following steps: dropping tilapia fries in an aquaculture pond for feed-based aquaculture for 28-31 days, fasting and refeeding the tilapia, and conducting the feed-based aquaculture until harvest.

2. The aquaculture method according to claim 1, wherein the tilapia fries each are 28-32 g.

3. The aquaculture method according to claim 1, wherein a stocking density of the tilapia fries is 1,800-2,200 fries/mu.

4. The aquaculture method according to claim 1, wherein the feed-based aquaculture is implemented by feeding the fries twice in an amount of 3-8% of total fry weight at 6:00 a.m. and 17:00 p.m. everyday.

5. The aquaculture method according to claim 4, wherein the fries are fed in the same quantity in each feeding.

6. The aquaculture method according to claim 1, wherein the fasting lasts for less than 21 days.

7. The aquaculture method according to claim 6, wherein the fasting lasts for 7-14 days.

8. The aquaculture method according to claim 1, wherein the refeeding is conducted in an incremental feeding pattern.

9. The aquaculture method according to claim 8, wherein daily feed quota in the incremental feeding is provided incrementally in an increment of 1-4% of fry weight at each stage until a final feeding rate reaches 3-8% of the fry weight.

10. The aquaculture method according to claim 9, wherein aquaculture time at each stage of the incremental feeding is 4-11 days.
